(19) United States
(12) Patent Application Publication
(10) Pub. No.: US 2016/0358182 A1
(43) Pub. Date: Dec. 8, 2016

(54) Method Of Managing Customer Relationships

(71) Applicant: Scott M. Spanbauer, Huntersville, NC (US)

(72) Inventor: Scott M. Spanbauer, Huntersville, NC (US)

(21) Appl. No.: 15/241,036

(22) Filed: Aug. 18, 2016

Related U.S. Application Data
(63) Continuation-in-part of application No. 14/038,320, filed on Sep. 26, 2013.

(51) Int. Cl. G06Q 30/00; G06Q 10/06

(52) U.S. Cl. CPC G06Q 30/01; G06Q 10/06393

(57) ABSTRACT

Described and depicted is a method for maintaining customer relationships that provides a true indicator of the health of a business relationship by quantifying the level of activity undertaken toward maintaining a relationship, according greater weight to favored and more recent and planned activities, which can be measured against a desired activity level.

### REFERENCE TO EARLIER APPLICATION

This Application incorporates by reference and, under 35 U.S.C. §120, is a continuation-in-part of U.S. patent application Ser. No. 14/038,320 filed on Sep. 26, 2013.

### RESERVATION OF COPYRIGHTS

Portions of the disclosure of this document contain material that is subject to copyright protection. The copyright owner has no objection to any reproduction of the document or disclosure as it appears in the Patent and Trademark Office records, but reserves all remaining rights under copyright.

### BACKGROUND OF THE INVENTION

Maintaining relationships with customers typically is a continuous process or else the relationships erode over time. Typically maintaining relationships with customers entails engaging each customer through one more activities over time, such as, but not limited to: corresponding by letter or email; setting a meeting; conducting a meeting; conducting a telephone conference; engaging in social media activities; researching; visiting a website; issuing a quote; closing a sale; conducting a video conference, engaging in instant messaging; attending an event; hosting an event. To assess effectiveness of an organization's relationship management efforts, the organization often will track activities undertaken, by whom and to what end: whether the customer remains retained.

Depending on the respective natures of the customer, customer contact, vendor, vendor representative, and the goods and services of interest, some activities may be found to be more effective than others. So, for tracking purposes, the organization may obtain more meaningful metrics as to the overall effectiveness of the organization's relationship management activities by assigning point values or weightage to each activity according to its effectiveness: activities found to be very effective having a high point value, and activities found to be less effective having a low point value. In practice, if a sales representative has completed a number of ineffective activities and another representative has completed a like number of more effective activities, then simply counting the number of activities each accomplished would not distinguish which representative was likely more effective. However, counting weighted points or points depreciated over time associated with each activity would show the former representative with a lower point value, and therefore probably less effective than the latter.

If not assigned strictly according to effectiveness, point values may be assigned to reflect organizational policy. For example, an organization in one industry or part of the world may find that transmitting facsimiles is customary, hence indicative of a good business, while another organization in another industry or location may find facsimiles regarded as old school, hence not indicative of local norms for a good business. Therefore, the former business may assign a high point value to transmitting facsimiles, while the latter business may not.

While points assignments for relationship-maintenance activities will likely influence activities employed and ultimately impact viability of the customer relationship, timing also should be factored in. For example, sending out one email per month, rather than 12 emails on January will likely have a better chance of, not only not irritating the recipient, but gently reminding the recipient of, and ultimately maintaining a good relationship. So, just as a relationship may depreciate or decay over time without maintenance activity, so too should the value or point-count associated with activities undertaken for maintaining the relationship.

For example, if all emails are valued the same regardless of when they are sent, then, at the end of the year, 12 emails sent would total 144 points whether the 12 were all sent in January, as shown in Table 1, or whether the emails were sent monthly (12 points times 12 months or 144 points).

TABLE 1
Depreciation of Single-Month Activities
Month

| JAN- | | | | | | | | | | | |
|---|---|---|---|---|---|---|---|---|---|---|---|
| UARY | FEBRUARY | MARCH | APRIL | MAY | JUNE | JULY | AUGUST | SEPTEMBER | OCTOBER | NOVEMBER | DECEMBER |
| 144 | 0 | 0 | 0 | 0 | 0 | 0 | 0 | 0 | 0 | 0 | 0 |

| | |
|---|---|
| Total Points | 144 |

On the other hand, if those same 12 emails were sent one per month, thus adding 12 points every month, then at the end of the year, with the point values for each email being depreciated by one point per month as above, then the total point value would be a more accurate representation of the relationship, as shown in Table 2 below.

TABLE 2
Depreciation of Distributed Activities
Month

| JANU- | | | | | | | | | | | |
|---|---|---|---|---|---|---|---|---|---|---|---|
| ARY | FEBRUARY | MARCH | APRIL | MAY | JUNE | JULY | AUGUST | SEPTEMBER | OCTOBER | NOVEMBER | DECEMBER |
| 12 | 11 | 10 | 9 | 8 | 7 | 6 | 5 | 4 | 3 | 2 | 1 |
| | 12 | 11 | 10 | 9 | 8 | 7 | 6 | 5 | 4 | 3 | 2 |
| | | 12 | 11 | 10 | 9 | 8 | 7 | 6 | 5 | 4 | 3 |
| | | | 12 | 11 | 10 | 9 | 8 | 7 | 6 | 5 | 4 |
| | | | | 12 | 11 | 10 | 9 | 8 | 7 | 6 | 5 |
| | | | | | 12 | 11 | 10 | 9 | 8 | 7 | 6 |
| | | | | | | 12 | 11 | 10 | 9 | 8 | 7 |
| | | | | | | | 12 | 11 | 10 | 9 | 8 |
| | | | | | | | | 12 | 11 | 10 | 9 |
| | | | | | | | | | 12 | 11 | 10 |
| | | | | | | | | | | 12 | 11 |
| | | | | | | | | | | | 12 |

| | |
|---|---|
| Total Points | 78 |

All things being equal, the point value ultimately tabulated via this depreciation model for monthly emails as compared with a single, first-of-the-year blast would be indicative of a true relationship activity level (TRAL). That is, consistent, regular, small relationship building activities rather than a single big activity will likely have greater positive impact on maintaining the relationship, thus more desirable.

Many Customer Relationship Management (CRM) software programs or databases have been developed over the years for managing and tracking relationship management activities and results thereof. CRM databases track information and serve as a centralized database for everyone to share information. They also act as repositories for past activities, past sales opportunities, documentation, and so forth. However, CRMs are not configured in a way that encourages employees to add information to the database beyond a sense of loyalty to the organization and knowing that is what is best for it.

CRM software programs fundamentally lack the drive for end users to put information into the database beyond the basics of contact information and revenue forecasts. Often, ineffective management of the people who are supposed to be using the software yields inconsistent results from the database. Consequently, information respecting effectiveness of relationship management activities is not complete, which causes pertinent reports to be inaccurate and management left to fill in the gaps with gut-level decisions as to their failings or next steps.

What organizations need is a fundamental driver for having end users enter timely information into an organization's CRM database. The answer lies in basing the CRM system on a depreciation model and monitoring the TRAL with respect to users and the customers they are supposed to be maintaining. Measuring TRAL reveals several critical factors that prior art systems are not capable of revealing.

First, TRAL reveals the truly valuable accounts and the contacts in the organization by highlighting the “current” contacts and customers worthy of development activities and helps to limit squandering resources on activities with respect to names in the database that no one has touched in too long of a time.

Second, TRAL changes the conversation within the internal sales team. Rather than focusing solely on revenue forecasts, the conversation includes discussions on current and future activity planning, and how recent and upcoming activities may create better relationships with customers and important contacts.

Third, TRAL readily recognizes employees that are really working to build relationships through planned activities and which ones are neglecting relationships.

The invention aids in tracking and measuring the health of a business relationship with existing customer relationships. This approach to measuring the activity generated in an existing relationship is an improvement over the subjective forms of estimating the health of the relationship. This new method allows the organization to assign point values to various sales and marketing activities. Over time these points are reduced or depreciated by a pre-determined rate (as assigned by the organization using this method). An up-to-date point total is kept so that the organization can see the current value as compared to a target or desired point value. If the point total falls below a minimum threshold, then the system alerts the organization to increase the activity level to bring the point total above the minimum.

What is needed and not taught or suggested in the prior art is a method for managing customer relationships that assesses the true relationship activity level and encourages participation in record-keeping activities by depreciating over time the points assigned for completing relationship-maintenance activities.

### BRIEF DESCRIPTION OF THE DRAWINGS

The invention is described in detail below with reference to the following figures, throughout which similar reference characters denote corresponding features consistently, wherein:

FIG. 1 is a schematic representation of an embodiment of a method of managing customer relationships configured according to principles of the invention;

FIG. 2 is a graphical representation of a display for implementing the method of FIG. 1;

FIG. 3 is a a graphical representation of a display generated by the method of FIG. 1; and

FIG. 4 is a graphical representation of a display for implementing the method of FIG. 1.

### DETAILED DESCRIPTION OF THE PREFERRED EMBODIMENTS

This disclosure is not limited in application to the details of construction and the arrangement of components set forth or illustrated in the drawings herein. The disclosure is capable of other embodiments and of being practiced or of being carried out in various ways. Phraseology and terminology used herein is for description and should not be regarded as limiting. Uses of “including,” “comprising” or “having” and variations thereof herein are meant to encompass the items listed thereafter and equivalents thereof as well as additional items. Unless limited otherwise, “connected,” “coupled” and “mounted,” and variations thereof herein are used broadly and encompass direct and indirect connections, couplings, and mountings. “Connected” and “coupled” and variations thereof are not restricted to physical or mechanical or electrical connections or couplings. Furthermore, and as described in subsequent paragraphs, the specific mechanical or electrical configurations described or illustrated are intended to exemplify embodiments of the disclosure. However, alternative mechanical or electrical configurations are possible, which are considered to be within the teachings of the disclosure. Furthermore, unless otherwise indicated, “or” is to be considered inclusive.

The invention is the first method for maintaining customer relationships that provides a true indicator of the health of a business relationship by quantifying the level of activity undertaken toward maintaining a relationship, according greater weight to favored and more recent and planned activities, which can be measured against a desired activity level.

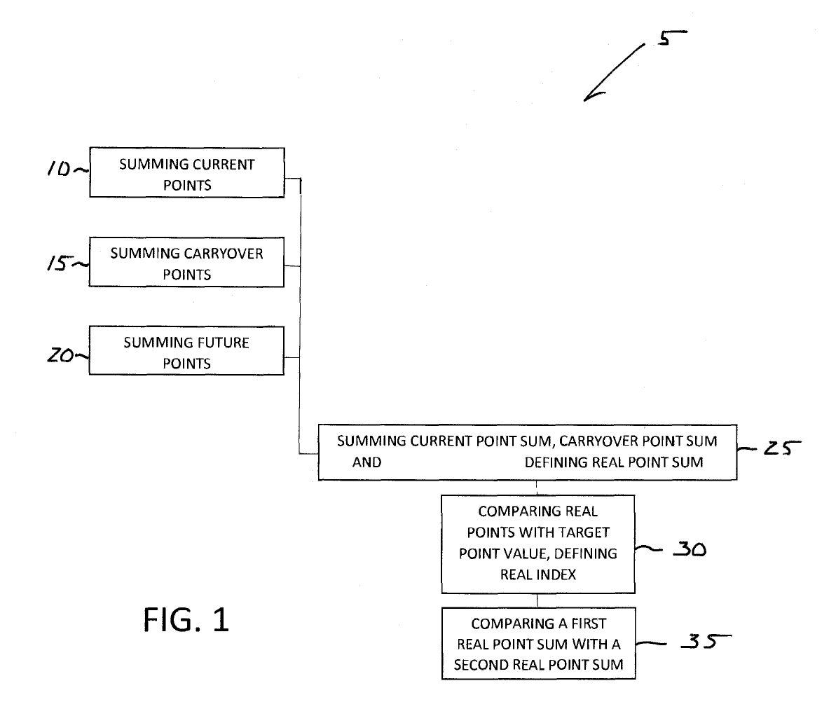

Referring to FIG. 1, an embodiment of a method of managing a customer relationship 5 configured according to principles of the invention includes: a step 10 of summing current points for activities completed within a specified period, for example on a specified day, like “today,” and defining a current point sum; a step 15 of summing carryover points for activities completed within another specified period, for example before the a specified day, and defining a carryover point sum; a step 20 of summing future points for activities completed within a further specified period, for example after the specified day, and defining a future point sum; and summing the current point sum, carryover point sum and future point sum, and defining a real point sum that truly quantifies the activity level associated with maintaining a relationship. Preferably, method 5 also includes the step 30 of comparing the real point sum with a target point value and defining a real index that ultimately quantifies the effort expended in maintaining a relationship.

Referring to Table 3 below, steps 10, 15 and 20, and steps dependent thereon, all depend on defining activities available for developing and maintaining a relationship and point values associated with each activity. The activities include, but are not limited to, any development activity, such as corresponding by letter or email; setting a meeting; conducting a meeting; conducting a telephone conference; engaging in social media activities; researching; visiting a website; issuing a quote; and closing a sale.

TABLE 3
Activity Definition

| | POINT | LIFE SPAN |
|---|---|---|
| ACTIVITY | VALUE | (months) |
| sending an email | 1.00 | 2.00 |
| writing a letter | 2.00 | 1.00 |
| setting a meeting | 3.00 | 1.00 |
| conducting a meeting | 8.00 | 2.00 |
| conducting a telephone conference | 5.00 | 1.00 |
| engaging in social media activities | 6.00 | 2.00 |
| researching | 7.00 | 3.00 |
| visiting a website | 8.00 | 1.00 |
| issuing a quote | 9.00 | 2.00 |
| closing a sale | 10.00 | 5.00 |

As mentioned above, points may be assigned to activities according to perceived effectiveness or by any scheme that obtains the results desired. For example, closing a sale may be regarded as a very effective activity for maintaining a customer relationship, thus accorded a high relative point value, because the activity is understood to reinforce or solidify a kinship or involvement in subject matter of mutual interest. On the other hand, sending an email that may not pass through a customer's spam filter or simply be deleted, may not be regarded as effective, thus accorded a relatively low point value.

Referring again to FIG. 1, step 10 of summing current points essentially involves querying the CRM database for a list of all of the activities performed with respect to a certain customer or relationship, looking up the points associated with those activities, and then summing up those points. For example, if a relationship manager engaged in the activities shown in Table 4 below regarding Customer A, or contacts associated with Customer A, then the current points for those activities would be summed as shown.

TABLE 4
Current Point Sum for Today's Activities regarding Customer A

| Activity | Points |
|---|---|
| conducting a meeting | 8 |
| engaging in social media activities | 6 |
| Current Point Sum | 14 |

Step 15 of summing carryover points is somewhat similar to step 10 except that, after a specified period of time has elapsed from when an activity was completed, points for each activity are depreciated by a respective depreciation factor. The period of time may be a day from when the activity was performed, the amount of time from when the activity was performed until midnight, hence the next day, or other increment. Rather than accounting for or giving equal weight for past activities as for recent activities, points for older activities are diminished consistent with the theory that a past activity is less likely to be fresh in mind or effective in reinforcing relationships, hence less effective as when the activity occurred. The depreciation factor is based on a life span for crediting or accounting for the point value. The life span represents the duration for depreciating the point value from its original point value as established in step 15 to a minimum value, preferably zero.

For example, referring again to Table 3 above, if the administrator of the CRM system implementing this method believes that the effectiveness, its impact on the customer relationship, of an activity, such as for writing a letter, endures for three months, then the life span for writing a letter may be set at 3 months. The depreciation factor is the fractional amount of lifespan renaming after the activity occurred. For example, if the life span for activity is 3 months, the activity depreciates at the rate of ⅓ of the total value per month. If the activity is writing a letter and we know the goodwill endures for 3 months and the value of the activity is 3 points then the activity would lose ⅓ of the value (1 point) after one month, ⅔ of the value (2 points) after two months, and all of the value (3 points) after the third month.

The Carryover Points for a past activity equal the point value attributed to the activity multiplied by the respective depreciation factor. Preferably, the Carryover Points are the remaining activity value, if any, after the activity begins to depreciate after 30 days have elapsed since activity completion. For example, in the letter writing scenario above, the Carryover Points would be equal to 2 points, or ⅓ deduction of the original 3-point value, after one month, 1 point, or ⅔ depreciation of the original 3-point value, after two months, and 0 points, full depreciation of original value, after the third month. For another example, if 2 months were to have elapsed since the activities tabulated in Table 4 above, then the Carryover Points for those activities would be summed as shown in Table 5 below.

TABLE 5
Carryover Point Sum for Activities occurring 2 months
ago regarding Customer A

| | | Depreciation | | | Depreciation | Carryover |
|---|---|---|---|---|---|---|
| Activity | Points | Calculation | | | Factor | Points |
| conducting a | 8 | −2.00 | * | 2.00 | −4.00 | 4.00 |
| meeting | | | | | | |
| engaging in social | 6 | −3.00 | * | 2.00 | −6.00 | 0.00 |
| media activities | | | | | | |

| | |
|---|---|
| Carryover Point Sum | 4.00 |

Referring again to FIG. 1, step 20 of summing future points is comparable to step 10 except that the full value of activity points attributed to an anticipated activity are only counted if they fall within the life span attributed to the activity. For example, if a meeting is scheduled for next week, then the points attributed for that activity would be counted. If the meeting were scheduled to occur in 2.5 months, it would fall outside the life span assigned to meetings and points therefor would not be counted. For example, revisiting again the example of Tables 4 and 5, if each activity were scheduled to occur 0.75 months from now, then the future points for those activities would be summed as shown in Table 6 below.

TABLE 6
Future Point Sum for Activities scheduled in 0.75
months regarding Customer A

| | | Within Life Span | Future |
|---|---|---|---|
| Activity | Points | (1 = yes, 0 = no) | Points |
| conducting a telephone conference | 5 | 1 | 5.00 |
| sending an email | 1 | 0 | 0.00 |
| Future Point Sum | | | 5.00 |

Alternatively, rather than using the same life span value for past and future activity point accounting, another period of time may be designated for accounting for future points as described herein.

Referring again to FIG. 1, preferably, step 25 includes summing only the Current Point Sum and Carryover Point Sum, thereby defining a real point sum. Drawing from the examples of Tables 4 and 5, the real points for the current and past activities would be summed as shown in Table 7 below.

TABLE 7
Real Point Sum for Past and Current Activities
regarding Customer A

| Activity Category | Points |
|---|---|
| Current Point Sum | 14.00 |
| Carryover Point Sum | 4.00 |
| Real Point Sum | 18.00 |

Alternatively, step 25 may also include summing with the Current Point Sum and Carryover Point Sum the Future Point Sum. Drawing from the examples of Tables 4, 5 and 6, the real points for the current, past and future activities would be summed as shown in Table 8 below.

TABLE 8
Real Point Sum for Past, Current and Future Activities
regarding Customer A

| Activity Category | Points |
|---|---|
| Current Point Sum | 14.00 |
| Carryover Point Sum | 4.00 |
| Future Point Sum | 5.00 |
| Real Point Sum | 23.00 |

Step 30 of comparing the real point sum with a target point value and defining a real index requires establishing a benchmark or goal for the amount of points that the customer relations manager believes is necessary for managing a relationship based on importance of contact and the desired level of prioritization above other contacts in the CRM system. The target point value can be virtually any positive real number, but likely is guided by experience and true appreciation of the health of the relationship in view of activities done in maintaining it. The target point value may be different for each customer, more important customers having a higher target point value less important customers having a lower target point value. Although relationships are highly subjective and not necessarily predictable, having a reasonable, well-founded target point value for comparison with the real point sum, which essentially encompasses past current and future efforts in maintaining the relationship, is a fair indicator of whether more or less activities may be needed for appropriate maintenance.

Since absolute point sums or differences from target point values may not per se indicate whether a little or significantly more effort may be needed to meet relationship maintenance goals, the method also includes generating a real index or score, which corresponds to or is the percentage of the real points divided by the target point value. For example, going back to the running example of Tables 4-7, if the target point value is 35, then the real index would be calculated by dividing 18 by 35, which would yield 0.514 or less than 52%, which would suggest that considerably more effort may need to be expended to meet the target point value to maintain the relationship.

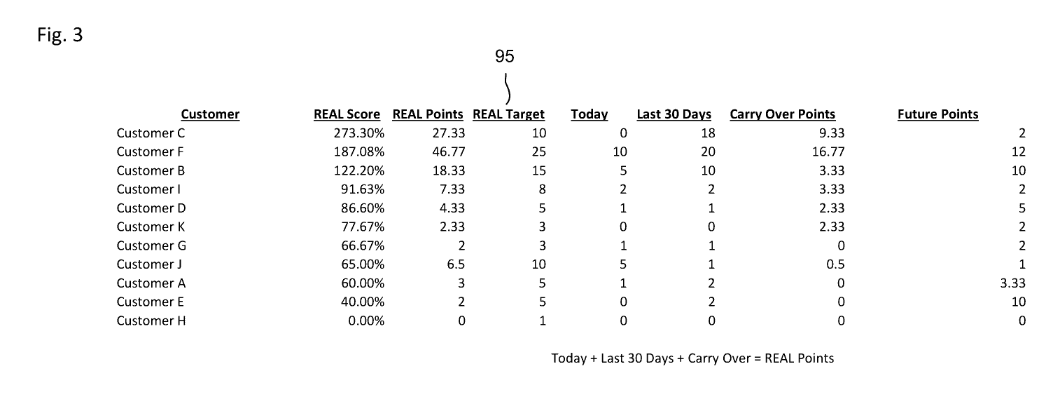

Referring to FIG. 3, another embodiment of the invention provides for ranking customers according to the level of engagement that an associated individual has therewith. For example, a sales manager responsible for a number of customers A-K is likely to be concerned whether any of those customers feel neglected or engaged insufficiently. Since the size and importance of a customer would dictate the customer's target point value, which is likely to be different than that for other customers, undertaking the same amount of activities for each customer would yield vastly different real indexes or scores for each. For example, a shown, the REAL Target 95 for the listed customers ranges from 1 for customer H through 25 for customer F. If the manager undertook the same amount of activities for each customer that resulted in 10 points for each, then the respective REAL indexes or Score would be 10/1=1000% and 10/25=40%. As shown in FIG. 3, since the REAL Targets vary among the customers shown, the REAL Score essentially is indicative of relationship health them according to a benchmark desired level of activity. The ratio of REAL Points to REAL Target therefore would be indicative of the sales manager's achievement of the desired level of engagement with a customer.

So as to aid the sales manager in deciding which customers merit more attention, preferably, the invention provides for generating and displaying a listing of customers ordered or ranked according to relative real indexes as shown in FIG. 3. The listing also may provide indicia, such as shading and font styling, to highlight or draw attention to which real index, hence relationship, is considered healthy. Those customers with REAL Scores above, e.g. 80%, could be considered healthy, while customers with REAL Scores below, e.g. 50%, could be considered neglected. These benchmarks are flexible and can be changed and modified by the organization to best reflect the norms for the business experiences and history. As shown, customers can be ranked, with the customers requiring the most attention at the bottom with REAL Score values of 50% or less, Customers E and Customer H.

The variation in the REAL Target values is an indicator by the relationship manager that the customers with higher value targets are the most important in the list and is another way to rank the list of customers. For example, customers with Target values such as 25, 15, and 10 are more important to the relationship manager than those customers with

Target values such as 1, 3 or 5. Not all customers are of equal importance to the organization and allowing for different Target values is another method for simulating the real world reality that relationship managers need to focus their time and energy appropriately to get the best results in their job.

Allowing for diverse Target values for each customer creates a challenge for ranking. It is not easy to compute and compare the different Targets and REAL Points values to rank customers. The REAL Score (percentage) allows for the comparison of different customers according to the amount of recent activity regardless of the actual Target value and actual REAL Points value. Converting the values to a percentage levels the playing field and makes ranking customers according to the amount of recent activity easy to accomplish and easy to understand.

REAL Scores can be greater than 100% as illustrated in FIG. 3. As more activity occurs the REAL Points total will continue to grow as well. The calculation will yield a higher percentage as a result of more activity. It should also be noted that if activity ceases that the REAL Points will depreciate, and eventually reach a value of 0. Over time this will also change the REAL Score percentage to 0 once all the REAL Points are exhausted thus simulating the real world customer relationship.

The REAL Score percentage will continue to change as REAL Points change. As more activity occurs, the REAL Points and REAL Score will increase. If no new activity takes place the REAL Points and REAL Score will decline due to neglect.

It is also possible to rank customers based on the current value of REAL Points in a similar way to ranking by REAL Score.

It is also possible to rank customers by Today points. It is also possible to rank customers by Last 30 Day points. It is also possible to rank customers on Carryover Points. All of these different methods of ranking (or sorting) customers shows a different perspective of the amount of recent activity with each customer and the health of the customer relationship in a quantitative and qualitative method of displaying the information. Relationship managers and organizations can determine the appropriate levels for what is deemed as a healthy customer relationship and a neglected customer relationship.

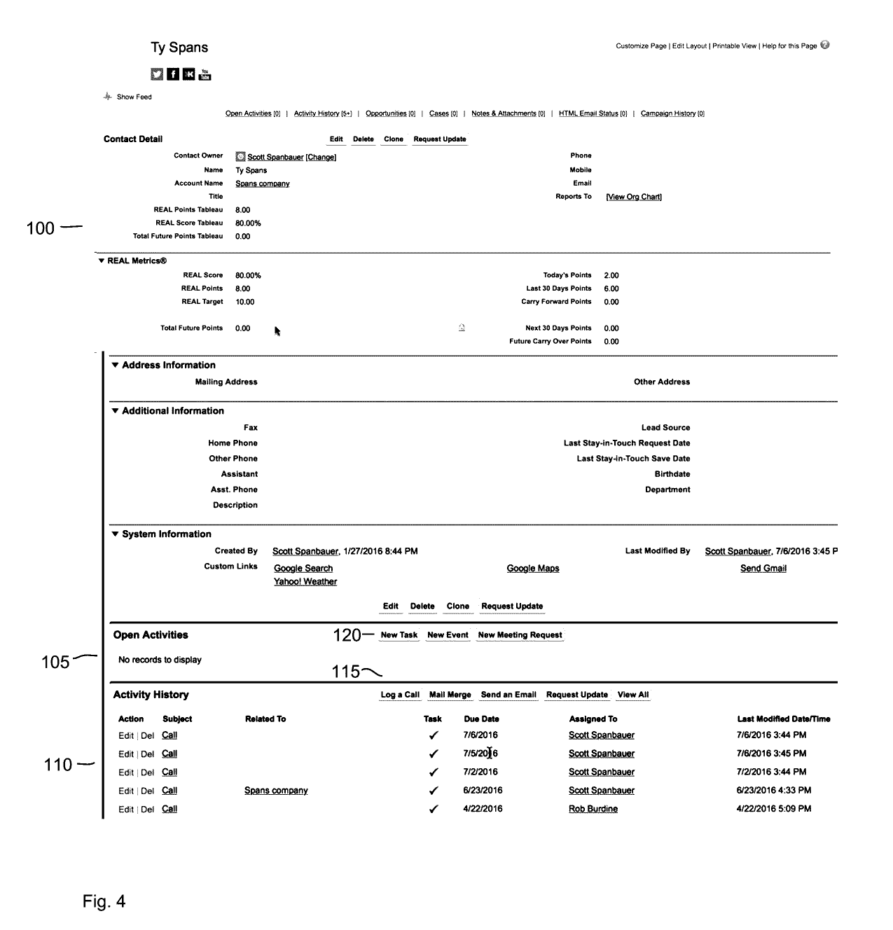

Referring to FIG. 4, the invention provides for displaying information respecting a customer selected from a ranked listing of customers, for example, the customer having the lowest real index. The information may include, but is not limited to, basic identifying information 100, a list of open activities 105 and a listing of activity history 110. The display also may provide for initiating a current activity 115, such as sending an email, and scheduling a future activity 120, such as requesting a meeting.

Another embodiment of the invention provides for a step 35 of comparing the real point sum of one relationship manager with a second real point sum of a second relationship manager. Alternatively, the step 35 may compare the real index of one relationship manager with a second real index of a second relationship manager. This essentially would reveal relative levels of effort expended in maintaining a relationship by those associated with the respective points and indices.

While all of the foregoing has been described in context of a single Customer A, the method may be applied for obtaining the sums and real indices for other customers as well. For relationship managers responsible for multiple customers, an average of all of the indices pertaining to each of the customers may be averaged to obtain an average real index for the manager, which may be compared with the average real indices obtained for other relationship managers. This may reveal the level of effort that one relationship manager is exerting relative to other relationship managers.

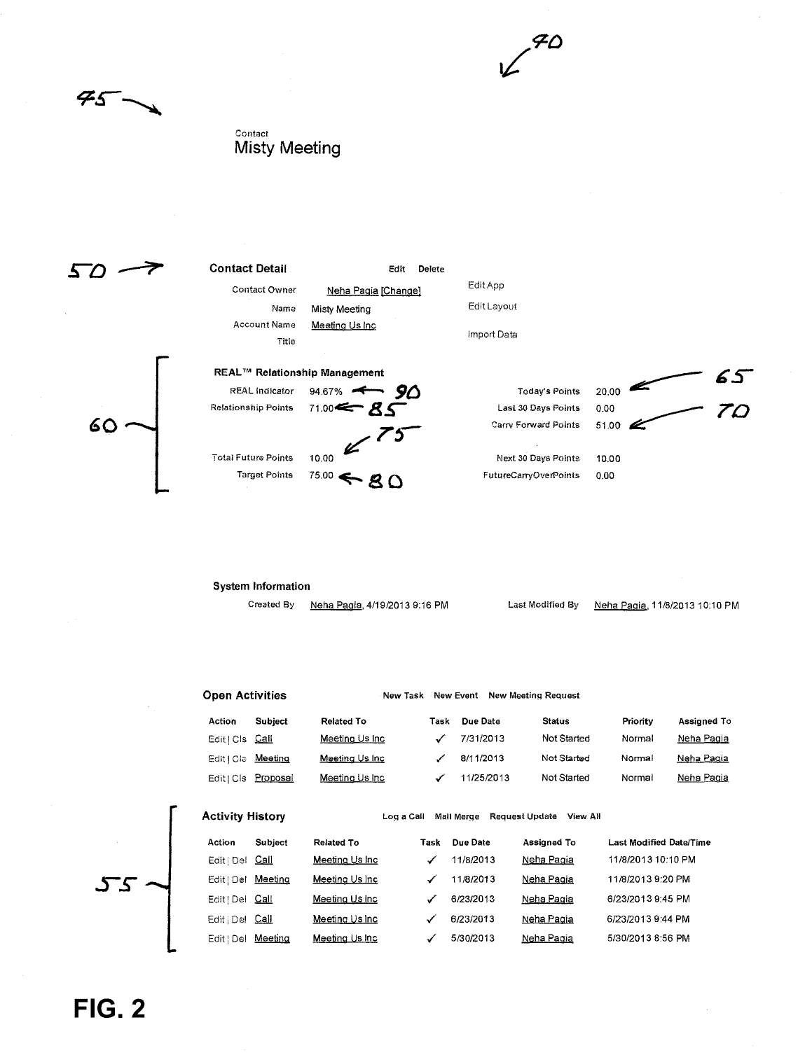

Referring to FIG. 2, in practice, the method may be implemented within a CRM system like Salesforce®. The CRM system may provide for a user display 40 that a relationship manager can use for recording activities performed for maintaining relationships. For example, display 40 provides a section 45 that identifies a customer to be managed; a section 50 that identifies the customer relationship manager; a section 55 that lists activities done; and a section 60 for displaying performance statistics. Section 60 includes: a section 65 that displays the current point sum; a section 70 that displays the carryover point sum; a section 75 that displays the future point sum; a section 80 that displays the target point value; a section 85 that displays the real points for the customer; and a section 90 that displays the real index for the customer.

To emphasize whether maintenance effort level is good, bad, critical, etc., the method includes displaying one or more of at least sections 85 and 90 with colored font or in color-shaded text boxes wherein the color is attuned to the level. For example, if the real index is greater than 90%, then the text or display box may be green to indicate satisfactory, between 80% and 90%, yellow to indicate concern, and below 80%, red to indicate critical.

The invention is not limited to the particular embodiments described and depicted herein, rather only to the following claims.

I claim:

1. Method of determining and displaying a real relationship ranking among a first party and second parties comprising:
defining an activity;
assigning a point value to the activity;
defining a period of time wherein the activity is current;
assigning a depreciation factor to the activity;
defining a target point value corresponding to a target level of engagement for each of n second parties;
calculating a carryover point sum corresponding to a product of the point value and the depreciation factor for each instance of the activity for which an amount of time elapsed since completion thereof exceeds the period of time for the first party relative to each of n second parties;
defining a real point sum as comprising the carryover point sum;
calculating a real index corresponding to a ratio of the real point sum divided by the target point value for the first party relative to each of n second parties;
calculating a relationship rank based on the respective real indexes for the first party relative to each of the n second parties that is indicative of the first party's relationship strength to each of the n second parties;
displaying a listing of the n second parties that is indicative of the relationship rank;
receiving a request for information respecting one of the n second parties selected from the listing; and, responsive to said receiving,
displaying the information.

2. Method of claim 1, further comprising:
assigning a life span to the activity, a corresponding remaining life span being a difference between the life span and time elapsed since completion of the activity;
wherein the depreciation factor corresponds to the remaining life span divided by the life span.

3. Method of claim 1, further comprising calculating a current point sum corresponding to the point value for each instance of the activity for which an amount of time elapsed since completion thereof does not exceed the period of time for the first party relative to each of n second parties;
wherein the real point sum further comprises the current point sum.

4. Method of claim 1, further comprising calculating a future point sum corresponding to the point value for each instance of the activity that has not been completed for the first party relative to each of n second parties;
wherein the real point sum further comprises the future point sum.

5. Method of claim 3, said calculating a future point sum further comprising multiplying the point value by discount value.

6. Method of claim 1, wherein the at least one activity is selected from: corresponding by letter; corresponding by email; setting a meeting; conducting a meeting; conducting a telephone conference; engaging in social media activities; researching; visiting a website; issuing a quote; closing a sale; conducting a video conference, engaging in instant messaging; attending an event; hosting an event and combinations thereof.
